(19) United States
(12) Patent Application Publication
(10) Pub. No.: US 2008/0145826 A1
(43) Pub. Date: Jun. 19, 2008

(54) Interactive hygiene training system

(76) Inventors: Jason C. Cohen, Appleton, WI (US); Christopher Michael Bechyne, Menasha, WI (US); Eric Donald Johnson, Larsen, WI (US); David William Koenig, Menasha, WI (US); Stephen Robert Kehn, Appleton, WI (US); Kenneth Thomas Borowski, Neenah, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/638,803

(22) Filed: Dec. 14, 2006

(51) Int. Cl. G09B 23/00; B65D 69/00

(52) U.S. Cl. 434/262; 206/581

(57) ABSTRACT

A method of providing a hygiene system includes providing a dispenser adapted to contain at least one product and deliver a dose of the product when activated; providing at least one applicator adapted to receive the dose of the product and transfer the dose of the product to a target surface; and providing a theme wherein the dispenser is adapted to simulate a first interactive component of the theme and the applicator is adapted to simulate a second interactive component of the theme.

### BACKGROUND OF THE INVENTION

Various methods of storing and dispensing cleaning compositions and personal care compositions are known in the art. For example, shampoos, soaps, conditioners, hard surface cleaners, lotions, sunscreens, and the like have been provided in bottles, cans, tubes, and other containers having various shapes, sizes, and dispensing methods. However, many of these containers are sized for adults and are hard for children to handle and/or dispense the product disposed therein. As such, the personal care compositions or cleaning compositions are often dispensed in inappropriate amounts because children lack the physical dexterity necessary to deliver the proper dose. In some situations, the children may be able to physically dispense the compositions but may lack the knowledge as to the amount required for the specific task thereby resulting in waste or an insufficient quantity to be effective.

Additionally, many dispensers containing cleaning and personal care compositions are essentially utilitarian in design and are not interesting for a child to use. This can be an additional source of frustration for children first learning personal hygiene (cleaning and/or caring for your body) or environmental hygiene (cleaning and/or caring for your surroundings).

Various attempts to make personal hygiene more accommodating and interesting to children have been undertaken. For example, colorful graphics have been added to packaging for shampoos, washes, lotions, and the like. Other attempts have also included various dispensers and bath toys manufactured to look like animals, cartoon characters, and other familiar objects. However, there still exists a need for methods, systems, and kits that are easy and interesting for kids to use, teach kids proper hygiene habits, and foster an interactive experience for caregivers and kids.

### SUMMARY OF THE INVENTION

In one aspect, the present invention is a method of providing a hygiene system. The method includes providing a dispenser adapted to contain at least one product and deliver a dose of the product when activated, providing at least one applicator adapted to receive the dose of the product and transfer the dose of the product to a target surface, and providing a theme wherein the dispenser is adapted to simulate a first interactive component of the theme and the applicator is adapted to simulate a second interactive component of the theme.

In some embodiments of the method, the applicator includes a compartment in fluid communication with an application surface.

In some embodiments, the method may further include providing instructions for an interaction between a caregiver and a child wherein the caregiver teaches proper hygiene by activating the dispenser and delivering the dose of the product, and the child learns proper hygiene by receiving the dose with the applicator and transferring the dose to the target surface.

In some embodiments, the product may be a personal care composition selected from the group consisting of shampoo, face wash, body wash, hair conditioner, detangler, moisturizing lotions, sun-protective materials, after-sun care materials, skin conditioning agents, antibacterial or antifungal materials, insect repellents, astringent materials, skin cleansers, antiseptics and disinfectants, agents for treating sensitive skin, oral care preparations, perfumes, toothpaste, and acne treatments.

In some embodiments, the product is a household cleaner selected from the group consisting of window cleaner, hard surface cleaner, dish soap, laundry soap, fabric softener, car wash, dust cleaner, floor cleaner, carpet cleaner, and car wax.

In some embodiments, the theme may be transportation and the dispenser may be adapted to simulate a fuel pump, tanker, space station, or gas can, and the applicator may be adapted to simulate a vehicle.

The method may also include, in some embodiments, providing a refiler, wherein the refiller may be adapted to: simulate a third interactive component of the theme, contain the product, and deliver the product into the dispenser when activated.

In some embodiments, the method includes providing the dispenser with a first dosing condition wherein activation of the dispenser delivers a first dose quantity; a second dosing condition wherein activation of the dispenser delivers a second dose quantity different than the first dose quantity; and a dose controller adapted to transition the dispenser from the first dosing condition to the second dosing condition and from the second dosing condition to the first dosing condition. In some embodiments, the method may further include providing instructions for training a child as to when to use the first dose quantity and when to use the second dose quantity.

In some embodiments, the method includes providing the dispenser with a first reservoir containing a first product and a second reservoir containing a second product different than the first product. In some embodiments, the method includes providing the dispenser with a first dispensing condition wherein activation of the dispenser delivers the first product, a second dispensing condition wherein activation of the dispenser delivers the second product, and a product selector adapted to transition the dispenser from the first dispensing condition to the second dispensing condition and from the second dispensing condition to the first dispensing condition. In some embodiments, the method further includes providing instructions as to how to train a child when to use the first product and when to use the second product. In some embodiments, the method may include providing a first product and a second product that are selected from the group consisting of hair shampoo, hair conditioner, face wash, body wash, bath oil, lotion, oral care preparation, and toothpaste.

In some embodiments, the method includes providing at least two applicators adapted to simulate an interactive component of the theme wherein a first applicator has a first design and a second applicator has a second design different than the first design. In some embodiments, the first applicator may be adapted to receive and transfer a first product and the second applicator may be adapted to receive and transfer a second product different than the first product.

In another aspect, the present invention provides a method of teaching hygiene. The method includes providing a dispenser adapted to simulate a first interactive component of a theme; providing a personal care composition within the dispenser; providing an applicator adapted to simulate a second interactive component of the theme; activating the dispenser to deliver a metered dose of the personal care composition; receiving the dose on the applicator; and transferring the personal care composition from the applicator to a portion of skin.

In some embodiments, the method may further include providing an array of applicators simulating interactive components of the theme.

In another aspect, the present invention provides a hygiene training kit. The kit includes a theme, a dispenser, and an applicator. The dispenser is adapted to simulate a first interactive component of the theme. The dispenser is also adapted to contain a product and dispense a dose of the product. The applicator is adapted to simulate a second interactive component of the theme. The applicator is also adapted to receive the dose of the product and transfer the dose of the product to a target surface.

In some embodiments, the product in the kit may be a personal hygiene is product selected from the group consisting of shampoo, face wash, body wash, hair conditioner, detangler, moisturizing lotions, sun-protective materials, after-sun care materials, skin conditioning agents, antibacterial or antifungal materials, insect repellents, astringent materials, skin cleansers; antiseptics and disinfectants, agents for treating sensitive skin, oral care preparations, perfumes, toothpaste, and acne treatments.

In some embodiments, the product in the kit may be an environmental hygiene product selected from the group consisting of window cleaner, hard surface cleaner, dish soap, laundry soap, fabric softener, car wash, dust cleaner, floor cleaner, carpet cleaner, and car wax.

### BRIEF DESCRIPTION OF THE DRAWINGS

FIG. 1 representatively illustrates an exemplary hygiene system of the present invention.

FIG. 2 representatively illustrates an exemplary hygiene system of the present invention.

### DETAILED DESCRIPTION OF THE INVENTION

The present invention relates to personal and environmental hygiene methods, systems, and kits that are easy and interesting for kids to use, teach kids proper hygiene habits, and foster an interactive experience for caregivers and kids. The present invention generally includes a dispenser, at least one applicator, and a theme wherein the theme is common to both the dispenser and the applicators.

In one aspect, the present invention is a method of providing a hygiene system. The method includes the steps of providing a dispenser, providing at least one applicator, and providing a theme. The dispenser is adapted to contain a product and to deliver a dose of the product when activated. The applicator is adapted to work with the dispenser to receive the dose of the product and transfer the dose of the product to a surface or location. The dispenser and the applicator share a common theme in that the dispenser is adapted to simulate a first interactive component of the theme and the applicator is adapted to simulate a second interactive component of the same theme.

As used herein, the term “theme” refers to a subject, topic, activity, or concept. Exemplary themes include “sports,” “playing sports,” “a specific sports team,” “fueling vehicles,” “outer space,” “extinguishing fires,” “feeding animals,” “food,” “seasons,” “holidays,” “travel,” and the like. In some embodiments, the theme may be based on a movie, book, story, or the like. For example, a theme may be “Moby Dick,” “Goldilocks,” “Jack and the Beanstalk,” and the like.

As used herein, the term “adapted to simulate” refers to an object that includes or has been transformed to include traits, characteristics, proportions, sounds, shapes, qualities, features, or other aspects traditionally associated with a generally recognized object, person, animal, or character sufficient to conjure the image of the generally recognized object, person, animal, or character in the mind of a person viewing the “adapted object.” The persons, animals, or characters may be living, dead, real, or fictional. For example, a plastic bottle formed in the shape of a pig would be “adapted to simulate a pig” because the shape of the bottle is sufficient to conjure the image of a pig in the mind of a person viewing the bottle. In another example, a sponge cut in the shape of a race car would be “adapted to simulate a race car.” In another example, a bottle having a portion formed in the shape of a unicorn's head and having a single horn protruding therefrom would be “adapted to simulate a unicorn.” In some embodiments, stickers, words, numbers, and the like may be included as one or more of the traits used to create the desired association. For example, a dispenser shaped as a fuel pump with stickers depicting gas pump gauges would be “adapted to simulate a fuel pump.” In another example, an applicator shaped as a race car with a number printed thereon would be “adapted to simulate a race car.” However, the term “adapted to simulate” is intended to exclude words, pictures, and graphics alone. For example, a bottle with a picture of a fictional cartoon character adhered thereto would not, by itself, “be adapted to simulate” the depicted fictional cartoon character.

As used herein, the term “interactive component” refers to an object, person, animal, or character generally recognized as being associated with a particular theme. For example, a “hockey” theme may include a hockey stick, hockey goal, hockey puck, skates, ice resurfacing machine, and the like as interactive components because they are physical objects associated with hockey. In another example, a “farm” theme may include interactive components such as tractors, animals, barns, and the like.

Any suitable personal hygiene product or products may be contained, delivered, received, and/or transferred in the various aspects and embodiments of the present invention. For example, personal hygiene products may include shampoo, face wash, body wash, hair conditioner, detangler, moisturizing lotions, sun-protective materials, after-sun care materials, skin conditioning agents, antibacterial or antifungal materials, insect repellents, astringent materials, skin cleansers, antiseptics and disinfectants, agents for treating sensitive skin, oral care preparations, perfumes, toothpaste, acne treatments, shaving cream, and the like. The personal hygiene products may be included in any suitable form. For example, the personal hygiene products, may be solids, semi-solids, liquids, lotions, creams, pastes, emulsions, pulverized solids, or granulated solids.

Likewise, any suitable environmental hygiene product or products may be contained, delivered, received, and/or transferred in the various aspects and embodiments of the present invention. For example, environmental hygiene products may include window cleaner, hard surface cleaner, dish soap, laundry soap, fabric softener, car wash, dust cleaner, floor cleaner, carpet cleaner, car wax, and the like. The environmental hygiene products may be included in any suitable form. For example, the environmental hygiene products, may be solids, semi-solids, liquids, lotions, creams, pastes, emulsions, pulverized solids, or granulated solids.

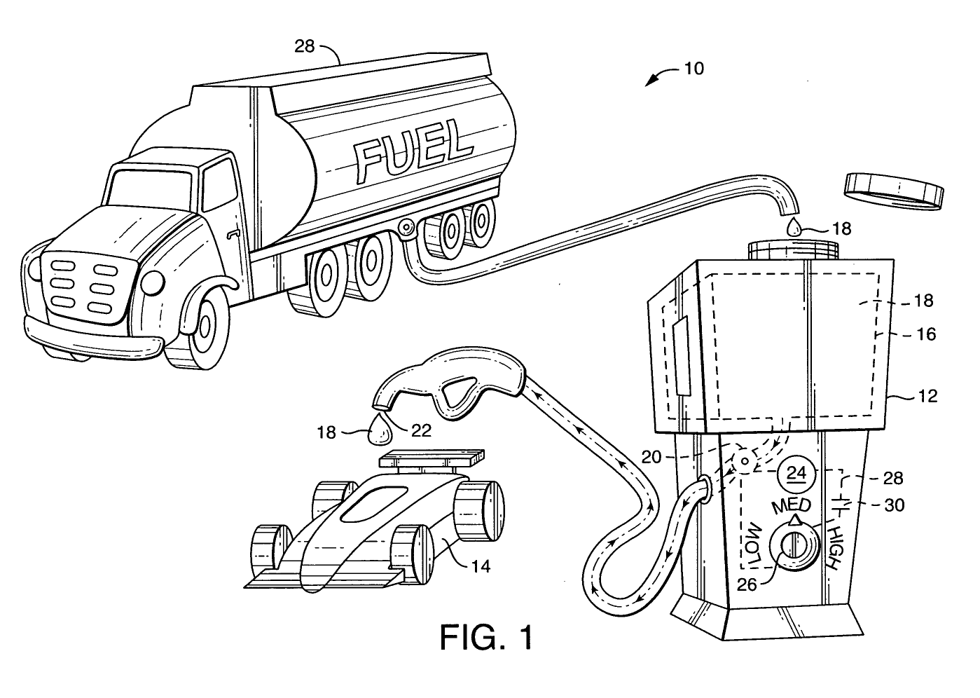

Referring now to FIG. 1, an exemplary hygiene system is illustrated generally at 10. The hygiene system 10 includes a dispenser 12 and an applicator 14, and a theme. The theme is “fueling vehicles” and the interactive components of this theme include a fuel pump and a car. The dispenser 12 is adapted to simulate a first interactive component of the theme, namely the gas pump. The applicator 14 is adapted to simulate a second interactive component of the theme, namely the race car. The dispenser 12 includes a reservoir 16 which is adapted to contain a product 18 therein.

As used herein, the term “adapted to contain” refers to on object such as a dispenser, reservoir, or compartment that is suitable to hold one or more personal hygiene products or environmental hygiene products therein. This term can describe a dispenser, reservoir, or compartment that is filled with a product or one that is empty but is adapted to be filled and/or refilled with various products as desired.

The dispenser 12 is adapted to deliver a dose of product 18 from a discharge port 22 by any suitable means when activated. As used herein, the term “adapted to deliver” refers to an object that can make a product stored therein available for use. The product may be “activated” and made available for use by any suitable means, such as, for example, pouring, squeezing, pumping, siphoning, extruding, rolling, pressure release, gravitational feed, and the like.

For example, as illustrated in FIG. 1, the dispenser 12 may include a delivery pump 20 in fluid communication with the reservoir 16 and the discharge port 22. The delivery pump 20 may be activated by any suitable trigger 24, such as a switch, to cause the delivery pump 20 to draw the product 18 from the reservoir 16 and expel a dose of the product 18 from the discharge port 22. In various embodiments, a trigger may activate the delivery device by any suitable means, such as, electrical current, mechanical actuation, remote signaling, and the like. In FIG. 1 the trigger 24 is illustrated as a switch within an electrical circuit 28. The circuit 28 further includes the delivery pump 20 and a power source 30.

In these embodiments, the trigger 24 may be operatively closed to complete the circuit 28 and allow power to flow to the delivery pump 20 which in turn moves the product 18 stored within the reservoir 16 to the discharge port 22. Additionally, the trigger 24 may be operatively opened to break the circuit 28 and thereby stop power from flowing to the delivery pump 20.

In various embodiments, a trigger may be located at any suitable position on the dispenser. For example, the trigger may be located closer to a discharge port such that the child may activate the dispenser. In some embodiments, a time delay and/or trigger lock may be included such that activation of the delivery device prevents the re-activation of the delivery device for a set period of time or until some other action has been performed, such as a reset. The timing delay or trigger lock may help prevent over dosing or unexpected dosing.

The applicator 14 is adapted to receive the dose of the product 18 delivered from the dispenser 12. As used herein, the term “adapted to receive” refers to objects suitable for absorbing, collecting or otherwise retaining a product applied thereon or therein. For example, a sponge having numerous open areas within the structure may be “adapted to receive” a product because at least a portion of the product applied thereto will be absorbed and/or retained. In another example, an applicator having a compartment may be “adapted to receive” a product because the product may be received into the compartment. In some embodiments, the product may also be contained and retained within the compartment.

After receiving the dose of the product 18, the applicator 14 is adapted to transfer the dose of the product to a surface or location by any suitable means. As used herein, the term “adapted to transfer” refers to objects with features that allow product retained and/or contained therein or thereon to be released and moved to a different location. For example, a sponge saturated with soap is adapted to transfer the soap because wiping the sponge against a surface will release the soap contained therein and thereon.

In another example, an applicator having a compartment in fluid communication with an application surface is “adapted to transfer” the product if the fluid can move from the compartment to the application surface wherein the product may be wiped against a target surface to move the product onto the target surface. For example, the applicator may have a valve between the compartment and the application surface wherein the valve may be opened to allow product to exit the compartment and move to the applicator surface wherein the product may be wiped against the target surface. In another example, the application surface may come into contact with the product in the compartment by rolling past the product, wicking, or other suitable means. In another example, the compartment may contain the product like a cup. In these embodiments, the application surface is defined as the exposed surface of the product and the applicator is adapted to transfer the product by pouring.

In various embodiments, any suitable theme may be employed. For example, the theme may be “outer space.” Interactive components of this theme may include, for example, space ships, stars, planets, comets, moons, asteroids, space stations, satellites, extra terrestrials, robots, and the like. Therefore, in some embodiments, a dispenser may be adapted to simulate a space station and the applicator may be adapted to simulate a space ship. As such, the dispenser and applicator are adapted to simulate first and second interactive components of the same theme.

This system may foster interaction between a caregiver and a child wherein the child controls the “space ship” applicator and “docks” with the “space station” dispenser controlled by the caregiver. The caregiver may then demonstrate the proper product selection and/or proper amount of product to use in the particular situation. The child may then receive the dose of product on or in the applicator and may transfer the product to another surface, such as the skin.

In some embodiments, the method of providing a hygiene system may further include providing instructions. For example, the instructions may explain ways in which the caregiver and the child can interact while using the hygiene system. The interaction may include the caregiver teaching proper hygiene by activating the dispenser and delivering a dose of the product. The interaction may further include the child learning proper hygiene by receiving the dose with the applicator and transferring the dose to the proper surface or location.

In another exemplary embodiment, the theme may be “pollination.” Interactive components of this theme may include, for example, bees, insects, flowers, trees, seeds, birds, and the like. Therefore, in some embodiments, a dispenser may be adapted to simulate a flower and the applicator may be adapted to simulate a bee. As such, the dispenser and applicator are adapted to simulate first and second interactive components of the same theme. This system may be utilized by a caregiver and a child wherein the child controls the “bee” applicator which gets “pollen” from the “flower” dispenser controlled by the caregiver.

In another exemplary embodiment, the theme may be “gardening.” Interactive components of this theme may include, for example, watering cans, seeds, hoes, rakes, water hoses, vegetables, the sun, clouds, rain clouds, and the like. Therefore, in some embodiments, a dispenser may be adapted to simulate a watering can and the applicator may be adapted to simulate a flower. As such, the dispenser and applicator are adapted to simulate first and second interactive components of the same theme. This system may be utilized by a caregiver and a child wherein the child controls the “flower” applicator which gets “watered” by the “watering can” dispenser controlled by the caregiver.

In another exemplary embodiment, the theme may be “fire fighting.” Interactive components of this theme may include, for example, fire trucks, fire fighters, Dalmatian dogs, fire hoses, fire extinguishers, ladders, fire axes, fire houses, camp fires, and the like. Therefore, in some embodiments, a dispenser may be adapted to simulate a fire extinguisher and the applicator may be adapted to simulate a camp fire. As such, the dispenser and applicator are adapted to simulate first and second interactive components of the same theme. This system may be utilized by a caregiver and a child wherein the child controls the “campfire” applicator which gets “extinguished” by the “fire extinguisher” dispenser controlled by the caregiver.

In another exemplary embodiment, the theme may be “food.” Interactive components of this theme may include, for example, mustard, ketchup, hot dogs, hamburgers, bratwurst, relish, and the like. Therefore, in some embodiments, a dispenser may be adapted to simulate a pump-action ketchup bottle and the applicator may be adapted to simulate a hot dog in a bun. As such, the dispenser and applicator are adapted to simulate first and second interactive components of the same theme. This system may be utilized by a caregiver and a child wherein the child controls the “hot dog” applicator which gets “ketchup” from the “ketchup bottle” dispenser controlled by the caregiver.

In another exemplary embodiment, the theme may be “a beauty parlor.” Interactive components of this theme may include, for example, hair wash sink, hair dryers, barber chairs, customers, barbers, beauticians, and the like.

Therefore, in some embodiments, a dispenser may be adapted to simulate a hair wash sink and the applicator may be adapted to simulate a customer. As such, the dispenser and applicator are adapted to simulate first and second interactive components of the same theme. This system may be utilized by a caregiver and a child wherein the child controls the “customer” applicator which gets “a hair wash” from the “wash sink” dispenser controlled by the caregiver.

In another exemplary embodiment, the theme may be a “quarry.” Interactive components of this theme may include, for example, rocks, trucks, conveyors, rock pulverizers, tractors, bulldozers, and the like. Therefore, in some embodiments, a dispenser may be adapted to simulate a rock pulverizer and the applicator may be adapted to simulate a dump truck. As such, the dispenser and applicator are adapted to simulate first and second interactive components of the same theme. This system may be utilized by a caregiver and a child wherein the caregiver or child loads “rocks” in the form of dried soap to the “pulverizer” dispenser, the pulverizer reduces the “rocks” to “gravel” which are dispensed into the “dump truck” applicator controlled by the child.

The dispensers of the present invention may be adapted to deliver a dose of product when activated. The dose may be any suitable size as appropriate for the particular application and/or product being dispensed. In various embodiments, the dispensers may include delivery pumps to produce a metered dose of product. The metered pumps may be of any suitable type, for example, manual plunge pumps, peristaltic pumps, siphon pumps, propeller pumps, and the like. In other embodiments, the dispenser may be adapted to deliver un-metered doses by pouring, squeezing, dumping, or the like.

As used herein, the term “dose” refers to the quantity of product delivered from the dispenser with a single activation thereof. In some embodiments, the dispenser may include a metered dose controller adapted to transition the dispenser from a first metered dosing condition to at least one additional metered dosing condition (i.e., a second, third, fourth, etc., metered dosing conditions). In the first metered dosing condition the dispenser is adapted to consistently deliver a metered dose having a first quantity upon activation. In the second metered dosing condition the dispenser is adapted to consistently deliver a metered dose having a second quantity upon activation. The second quantity is different than the first quantity.

Referring again to FIG. 1, the dispenser 12 is illustrated as including a metered dose controller 26 and having three metered dosing conditions: low, medium, and high. Some methods of training may include the caregiver selecting the amount of product to be dispensed depending upon the cleaning situation. For example, a small child may require a relatively small dose whereas a larger child may require a larger dose. In another example, a caregiver may want to deliver a large dose when the child is particularly dirty.

The metered dose controller 26 may be adapted to change the dosing condition in any suitable manner. For example, the dose controller 26 may be adapted to change the stroke length of a manual pump wherein the amount of product dispensed with a single pump changes. In another example, as illustrated in FIG. 1, the dose controller 26 may be a rheostat that regulates the speed of the delivery pump 20. In some embodiments, the dose controller may regulate the resistance in the system to flow, such as by changing orifice size. In other words, the output as a function of time may be increased or decreased by various means. In another example, the metered dose controller may include a timer that controls the duration of time during which the pump delivers. In other words, the output as a function of time may be the same, but the time the pump is operating may be increased or decreased. Combinations of pump output and duration are also contemplated.

In some embodiments, a dispenser may include a first reservoir containing a first product and at least one additional reservoir containing at least one additional product different than the first product. For example, a dispenser may include a first reservoir containing a hair shampoo, a second reservoir containing a conditioner, and a third reservoir containing a body wash.

In some embodiments, a dispenser may have a first product dispensing condition, at least one additional product dispensing condition, and a product selector. In the first product dispending condition, the dispenser may be adapted to deliver a first product when activated. In a second product dispensing condition, the dispenser may be adapted to deliver a second product when activated. The product selector may be adapted to transition the dispenser from the first product dispensing condition to the second product dispensing condition and from the second product dispensing condition to the first product dispensing condition. In some embodiments, the methods of the present invention may also include providing instructions for training a child when to use the first product and when to use the second product.

In various methods of teaching hygiene, the various products may be dispensed in various orders and with various metered doses to teach the child proper cleaning sequence and proper dosing size. For example, the product selector and the dose controller may be manipulated by a caregiver such that a first amount of shampoo for washing the hair is dispensed when activated. The product selector and the dose controller may then be manipulated by a caregiver such that a second amount of conditioner is dispensed when activated. Finally, the product selector and dose controller may be manipulated by a caregiver such that a third amount of body wash is dispensed when the dispenser is activated. The first, second, and third amounts may be any suitable size depending on the product being dispensed and the specific hygiene needs being addressed. The dosing quantities may be the same or may be different for the different product dispensing conditions.

In these embodiments, the caregiver may use the interactive experience to teach the child which product to use and the proper amount to use in various situations. In some embodiments, the method may further include providing instructions to use the systems described herein to train a child as to when to use the first dose quantity, when to use the second dose quantity, when to use the first product, when to the use the second product, and combinations thereof.

In some embodiments, the dispensers and/or applicators may include sensors and/or electronics to aid in the learning, fun, and interaction. For example, sound, lights, movement, and the like, and combinations thereof may be incorporated. For example, a dispenser adapted to simulate a gas pump may include the “dinging” sound associated with gas pumps. In another example, bees may buzz, motors may rev, cows may moo, etc. In some embodiments, some trigger event, such as the activation of the dispenser, the movement of some part of the dispenser, a proximity switch, or the like may be used to initiate an electrical signal to cause a sound from a sound-generating device.

In some embodiments, radio frequency identification (RFID) technology may be used. For example, an RFID tag may be located in the applicator and an RFID reader may be located in the dispenser such that when the applicator is proximate the dispenser, the dispenser is activated. In other embodiments, the RFID reader in the dispenser may determine whether the proper applicator is being used with the proper product. For example, a toothbrush applicator may have an RFID tag located therein such that a warning is sounded if products other than toothpaste are about to be dispense thereon.

In other embodiments, the RFID tag in the applicators may activate a specialized sound in the dispenser. For example, a dispenser may be adapted to simulate a barn and the applicators may be adapted to simulate various barnyard animals. The applicators may include information on an RFID tag located therein such that the appropriate sound is generated, when proximate the dispenser, based on the particular animal being simulated.

In various embodiments, the dispensers may be made from a variety of materials such as various thermoplastic polymers (polystyrene, polyethylene, polypropylene, polyester, polyamides, acrylics, and the like), thermoplastic elastomers, metals, glass, ceramic materials, etc. using a wide variety of known manufacturing procedures (e.g., injection molding, blow molding, glass blowing, etc.). The material is also desirably capable of withstanding chemical attack by the product originally stored therein. In some embodiments, the dispenser material may be impact resistant.

In various embodiments, the reservoirs within the dispensers may be provided with or without product included therein. In some embodiments, the reservoirs may be adapted to be refillable. In some embodiments, the system may further include a refiner wherein the refiller contains product therein and is adapted to deliver the product to the dispenser as needed. In some embodiments, the refiner may be adapted to simulate a third interactive component of the theme. For example, as illustrated in FIG. 1, a refiner 28 is adapted to simulate a fuel tanker truck which is an interactive component of the theme, “fueling vehicles.” This can be used to teach a child how to use refills, conserve packaging, etc. Therefore, in some embodiments, the methods disclosed herein may further include providing a refiller, wherein the refiller is adapted to: simulate a third interactive component of the theme, contain the product, and deliver the product into the dispenser when activated. The methods may further include delivering the product from the refiller into the dispenser.

The applicators may be made of any suitable material or combinations of materials. For example, portions of the applicator may be made of foam, sponge, woven fabric, non-woven fabric, rubber, metal, glass, ceramic, thermoplastic polymers, or any other suitable material. In some examples, all or a part of the applicators may be made of natural or synthetic sponge material. In some embodiments, the applicators may have a compartment in fluid communication with an application surface. The compartment may be made of any suitable material and the application surface may be made of any suitable material.

For example, a “magic wand” applicator may include a tubular body and a foam tip. The tubular body may include one or more compartments and the compartments may be in fluid communication with the tip which is the application surface. In use, the dispenser would provide a dose of product which would be received and retained in the compartment of the applicator. The product may then be moved from the compartment to the application surface by any suitable means through any suitable structures such as a valve for example. The product may then be applied to any suitable surface via contact with the application surface.

In various embodiments, the application surface may be a roller ball adapted to contact product within the compartment and transfer the product to the surface when rotated. For example, a dispenser may deliver a dose of sunscreen to a compartment of an applicator. The applicator may include a roller ball in fluid communication with the compartment such that when the roller ball is moved across the skin, the sunscreen within the compartment is transferred to the skin via the surface of the roller ball.

In some embodiments, more than one applicator may be provided for use with a dispenser. For example, a dispenser may be adapted to simulate a gas pump and a first applicator may be adapted to simulate a first popular race car and a second applicator may be adapted to simulate a second popular race car wherein the first and second race cars are different. For example, a plurality of applicators, each simulating different race cars within a common racing series or organization, may be provided as a collection. In other embodiments, applicators simulating different race cars may be provided separately but be adapted to use with a common dispenser.

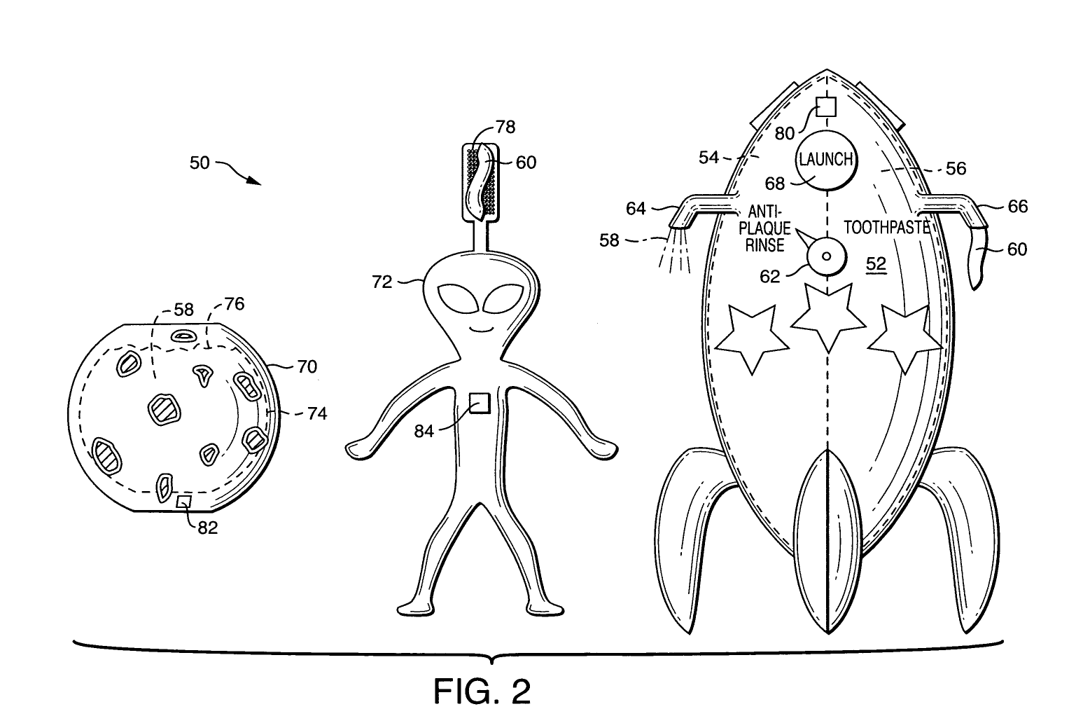

In some embodiments, different applicators simulating different interactive components may have the same theme but may be adapted to receive and apply different products. For example, referring to FIG. 2, a hygiene system is illustrated generally at 50. The hygiene system 50 includes a theme, “space.” The hygiene system 50 further includes a dispenser 52. The dispenser 52 is adapted to simulate a rocket which is a first interactive component of the theme “space.” The dispenser 52 contains a first reservoir 54 and a second reservoir 56. The first reservoir 54 is adapted to receive and/or contain a first product 58 therein and the second reservoir 56 is adapted to receive and/or contain a second product 60 therein. The dispenser 52 is further adapted to deliver a dose of either the first product 58 or the second product 60 when activated by a trigger 68.

To determine which product is dispensed, the dispenser 52 also includes a product selector 62. The product selector 62 is adapted to transition the dispenser from a first dispensing condition to a second dispensing condition and from the second dispensing condition to the first dispensing condition as desired by the user. In the first dispensing condition, the dispenser 52 is adapted to deliver the first product 58 from the first reservoir 54 to a first discharge port 64. Likewise, in the second dispensing condition, the dispenser 52 is adapted to deliver the second product 60 from the second reservoir 56 to a second discharge port 66.

The hygiene system 50 also includes a first applicator 70 and a second applicator 72. The first applicator 70 is adapted to simulate the moon which is a second interactive component of the theme, “space.” The second applicator 72 is adapted to simulate a space alien which is a third interactive component of the theme.

The first applicator 70 has a compartment 74 adapted to receive the first product 58 from the first discharge port 64. The upper surface of the compartment 74 is an application surface 76 in this embodiment. The compartment 74 in FIG. 2 is essentially a void space within the first applicator 70 thereby creating a cup. The compartment 74 is adapted to transfer the dose of the first product by pouring the dose from the compartment 74.

The second applicator 72 is adapted to receive the second product 60 from the second discharge port 66. The second applicator 72 includes a bristle surface 78 which is adapted to receive the second product 60 thereon. The second applicator 72 is adapted to transfer the dose of the second product 60 from the bristle surface 78 to the teeth.

In use, the hygiene system 50 may promote a learning interaction between a caregiver and a child with regard to oral hygiene. Specifically, a method of providing a system may include providing the system 50 and may include providing instructions to enable caregivers to use the system as follows. The dispenser 52 may be provided with the first product 58 within first reservoir 54 or may be adapted to receive the first product 58 within the reservoir 54. In the illustrated embodiment, the dispenser 52 is adapted to simulate a rocket and the first product 58 is an anti-plaque rinse. The product selector 62 may be manipulated such that the dispenser is in the first product mode and activation of the trigger 68 delivers a dose of anti-plaque rinse from the first reservoir 54 to the first discharge port 64. The dose of anti-plaque rinse is received by the first applicator 70. In the illustrated embodiment, the first applicator 70 is a cup adapted to simulate the moon. In various embodiments, instructions may direct the caregiver to operate the dispenser and the child to operate the applicator.

The dispenser 52 is also provided with the second product 60 within second reservoir 56 or may be adapted to receive the second product 60 within the second reservoir 56. In the illustrated embodiment, the second product 60 is toothpaste. The product selector 62 may be manipulated such that the dispenser is in the second product mode and activation of the trigger 68 delivers a dose of toothpaste from the second reservoir 56 to the second discharge port 66. The dose of toothpaste is received by the second applicator 72. In the illustrated embodiment, the second applicator 72 is a toothbrush adapted to simulate an alien. In various embodiments, instructions may direct the caregiver to teach personal hygiene by operating the dispenser to deliver the first and second products 58 and 60 in the proper order and at the proper dosage. The instructions may direct the child to learn personal hygiene by operating the first and second applicators 70 and 72 in the proper order to receive the first and second products 58 and 60 at the proper dosages. From this interaction, the child may have fun learning about oral hygiene.

In various embodiments, the hygiene system 50 illustrated in FIG. 2, may further include an RFID system. The RFID system may include an RFID reader 80 located in the dispenser 52, a first RFID tag 82 located on or in the first applicator 70, and a second RFID tag 84 located on or within the second applicator 72. The RFID system may be configured such that the RFID reader 80 identifies whether the first applicator 70 or the second applicator 72 is being presented to the dispenser 52 and either automatically dispenses the proper product and the proper dosage or only permits the dispenser 52 to be activated if the product selector 62 to set to the proper delivery condition and the proper dispenser is proximate the proper discharge port. This system may be used to minimize incorrect dosing. For example, this system would prevent toothpaste from being dispensed into the first applicator and/or anti-plaque rinse from being dispensed onto the second applicator.

Those skilled in the art will readily appreciate that many other combinations are possible. For example, some systems may include two different triggers wherein each reservoir had one. In these embodiments, the product selector would not be necessary because the caregiver could select the desired product simply by pressing the trigger associated with that product. Likewise, in various embodiments, the first and second products may be dispensed from a common discharge port.

In some aspects, the present invention may be a hygiene training kit. The kit may include a theme, a dispenser adapted to simulate a first interactive component of the theme, and an at least one applicator adapted to simulate a second interactive component of the theme. The dispenser is adapted to contain at least one product and dispense at least one dose of the product. The applicator is adapted to receive the dose of the product and is adapted to transfer the dose of the product to one or more surfaces or locations. Any suitable theme, applicator, dispenser, and combinations thereof may be included in hygiene training kits.

In various embodiments, the dispensers and applicators described herein may be a part of method for teaching hygiene. In one aspect, a method of teaching hygiene includes providing a dispenser adapted to simulate a first interactive component of a theme; providing a personal care composition within the dispenser or enabling a personal care composition to be added to the dispenser; providing an applicator adapted to simulate a second interactive component of the theme; activating the dispenser to deliver a metered dose of the personal care composition; receiving the dose on or in the applicator; and transferring the personal care composition from the applicator to the skin, body, or target surface.

This method can be used to create an interaction between the caregiver and the child. For example, the caregiver may activate the dispenser to provide the dose. In some embodiments, the caregiver may also adjust the dose controller and/or the product selector to deliver an appropriate amount of the desired composition from the dispenser. Likewise, the child may control the applicator and receive the dose from the dispenser. The child may then see and use a proper amount thereby helping the child learn how much product is needed for various hygiene tasks.

In another aspect, a method of teaching hygiene includes providing a dispenser adapted to simulate a first interactive component of a theme; providing an environmental hygiene product within the dispenser; providing an applicator adapted to simulate a second interactive component of the theme; activating the dispenser to deliver a metered dose of the environmental hygiene composition; receiving the dose on or in the applicator; and transferring the environmental hygiene product from the applicator to a target surface to be cleaned or treated.

In some embodiments, the nature of the interaction may change from a first configuration to a second configuration. For example, a system used with a younger child may have a first configuration wherein the dispenser gas pump is adapted to dispense product without “paying.” As the child matures, the system may be transitioned to a second configuration wherein the child puts “money” into the dispenser (i.e., “pays”) before the product dispenses thereby teaching a child the exchange of goods for money.

All combinations of the dispensers, applicators, themes, dose controllers, and product selectors are contemplated herein. Furthermore, while the invention has been described in detail with respect to specific embodiments thereof, it will be appreciated that those skilled in the art, upon attaining understanding of the foregoing will readily appreciate alterations to, variation of, and equivalents to these embodiments. Accordingly, the scope of the present invention should be assessed as that of the appended claims and any equivalents thereto.

1. A method of providing a hygiene system comprising,
providing a dispenser adapted to contain at least one product and deliver a dose of the product when activated;
providing at least one applicator adapted to receive the dose of the product and transfer the dose of the product to a target surface; and
providing a theme wherein the dispenser is adapted to simulate a first interactive component of the theme and the applicator is adapted to simulate a second interactive component of the theme.

2. The method of claim 1 wherein the applicator includes a compartment in fluid communication with an application surface.

3. The method of claim 1 further comprising providing instructions for an interaction between a caregiver and a child wherein the caregiver teaches proper hygiene by activating the dispenser and delivering the dose of the product and the child learns proper hygiene by receiving the dose with the applicator and transferring the dose to the target surface.

4. The method of claim 1 wherein the product is a personal care composition selected from the group consisting of shampoo, face wash, body wash, hair conditioner, detangler, moisturizing lotions, sun-protective materials, after-sun care materials, skin conditioning agents, antibacterial or antifungal materials, insect repellents, astringent materials, skin cleansers, antiseptics and disinfectants, agents for treating sensitive skin, oral care preparations, perfumes, toothpaste, and acne treatments.

5. The method of claim 4 wherein the theme is transportation and the dispenser is adapted to simulate a fuel pump, tanker, space station, or gas can and the applicator is adapted to simulate a vehicle.

6. The method of claim 1 wherein the product is a household cleaner selected from the group consisting of window cleaner, hard surface cleaner, dish soap, laundry soap, fabric softener, car wash, dust cleaner, floor cleaner, carpet cleaner, and car wax.

7. The method of claim 1 further comprising providing a refiller, wherein the refiner is adapted to: simulate a third interactive component of the theme, contain the product, and deliver the product into the dispenser when activated.

8. The method of claim 1 wherein the dispenser comprises,
a first dosing condition wherein activation of the dispenser delivers a first dose quantity;
a second dosing condition wherein activation of the dispenser delivers a second dose quantity different than the first dose quantity; and
a dose controller adapted to transition the dispenser from the first dosing condition to the second dosing condition and from the second dosing condition to the first dosing condition.

9. The method of claim 8 further comprising providing instructions for training a child as to when to use the first dose quantity and when to use the second dose quantity.

10. The method of claim 1 wherein the dispenser comprises,
a first reservoir containing a first product and
a second reservoir containing a second product different than the first product.

11. The method of claim 10 wherein the dispenser comprises,
a first dispensing condition wherein activation of the dispenser delivers the first product,
a second dispensing condition wherein activation of the dispenser delivers the second product, and
a product selector adapted to transition the dispenser from the first dispensing condition to the second dispensing condition and from the second dispensing condition to the first dispensing condition.

12. The method of claim 11 further comprising providing instructions as to how to train a child when to use the first product and when to use the second product.

13. The method of claim 12 wherein the first product and the second product are selected from the group consisting of hair shampoo, hair conditioner, face wash, body wash, bath oil, lotion, oral care preparation, and toothpaste.

14. The method of claim 1 further comprising providing at least two applicators adapted to simulate an interactive component of the theme wherein a first applicator has a first design and a second applicator has a second design different than the first design.

15. The method of claim 14 wherein the first applicator is adapted to receive and transfer a first product and the second applicator is adapted to receive and transfer a second product different than the first product.

16. A method of teaching hygiene comprising,
providing a dispenser adapted to simulate a first interactive component of a theme;
providing a personal care composition within the dispenser;
providing an applicator adapted to simulate a second interactive component of the theme;
activating the dispenser to deliver a metered dose of the personal care composition;
receiving the dose on the applicator; and
transferring the personal care composition from the applicator to a target surface.

17. The method of claim 16 further comprising providing an array of applicators simulating interactive components of the theme.

18. A hygiene training kit comprising,
a theme;
a dispenser simulating a first interactive component of the theme, wherein the dispenser is adapted to contain a product and dispense a dose of the product; and
an applicator simulating a second interactive component of the theme, wherein the applicator is adapted to receive the dose of the product and is adapted to transfer the dose of the product to a target surface.

19. The hygiene training kit of claim 18 wherein the product is a personal hygiene product selected from the group consisting of shampoo, face wash, body wash, hair conditioner, detangler, moisturizing lotions, sun-protective materials, after-sun care materials, skin conditioning agents, antibacterial or antifungal materials, insect repellents, astringent materials, skin cleansers, antiseptics and disinfectants, agents for treating sensitive skin, oral care preparations, perfumes, toothpaste, and acne treatments.

20. The hygiene training kit of claim 18 wherein the product is an environmental hygiene product selected from the group consisting of window cleaner, hard surface cleaner, dish soap, laundry soap, fabric softener, car wash, dust cleaner, floor cleaner, carpet cleaner, and car wax.
